(19) United States
(12) Patent Application Publication
(10) Pub. No.: US 2011/0086199 A1
(43) Pub. Date: Apr. 14, 2011

(54) METHOD AND DEVICE FOR PRODUCING A CURVED PROFILE MADE FROM COMPOSITE MATERIAL AND RESULTING PROFILE

(75) Inventors: Gilles Duqueine, Fontaines Sur Saone (FR); Jerome Aubry, Saint Baudille De La Tour (FR)

(73) Assignee: AIRBUS, BLAGNAC (FR)

(21) Appl. No.: 12/920,922

(22) PCT Filed: Mar. 5, 2009
(86) PCT No.: PCT/FR09/50357

§ 371 Date: Dec. 13, 2010

(30) Foreign Application Priority Data
Mar. 7, 2008 (FR) 0801261

(51) Int. Cl. B29C 70/20; B23P 17/00; B32B 37/14; B32B 38/18; B32B 5/26; B32B 5/28; B32B 3/14

(52) U.S. Cl. 428/112; 29/419.1; 156/538; 156/475; 428/107; 428/174

(57) ABSTRACT

A method and a device for realizing a curved composite material profile made of composite material, and to the resulting profile (63), in which the profile is made from at least one composite strip (11) extending along a longitudinal axis. The strip is formed by stacking at least two tapes of unidirectional reinforcing fibers (4, 5, 6) arranged in orientations. The strip is laid up on a template (34, 73) having a flat or substantially flat application surface (36) with a generally elongated shape, with a specified configuration corresponding to the desired profile and extending around a reference line, by gradually applying the strip and simultaneously deforming it along the reference line, such that a gradual fanning of the fibers in the application plane is realized on the part or parts having a non-zero curvature radius

The present invention relates to a method for realizing a profile made of a composite material having a configuration with at least a first part having a non-zero curvature radius, out of at least one composite stripstrip extending along a longitudinal axis.

It also relates to a device implementing such a method and a corresponding profile made of a composite material.

It has a particularly important, though not exclusive, application in the field of manufacturing high-strength curved members, for example in the field of aeronautics for manufacturing aircraft fuselage frames.

But it can also be used in other fields requiring good stress resistance, such as leisure and competition sports.

Devices and methods are already known for realizing curved profiles made of composite material formed of impregnated reinforcing fibers, laid up wire-by-wire by robots to obtain a proper orientation of the fibers so as to optimize the strength properties.

Such a wire-by-wire layup requires the use of complex machines such as automatic fiber placement machines, and has significant disadvantages linked to the requirement for very high accuracy and to the high cost of the manufacturing equipment.

These lead to costly investments for low productivity and a result with regard to the fanning out the fibers while they are being positioned which unfortunately does not allow good uniformity.

This invention seeks to provide a method, a device and profiles better fulfilling the requirements of the practice than those previously known, particularly in that it makes it possible to obtain a profile made of a composite material in which the layup of the unidirectional pre-impregnated layers is perfectly uniform, at low cost, thanks to the realization of a strip, not yet deformed but that will, once stretched by bending, significantly increase the mechanical performance of the final product.

To this purpose, the invention essentially proposes a method for realizing a profile made of a composite material having a configuration with at least a first part having a non-zero curvature radius, from at least one composite strip extending along a longitudinal axis,

characterized in that the strip being formed by stacking at least two tapes of unidirectional reinforcing fibers arranged in orientations different to the longitudinal axis of the strip and each other, the tapes being pre-impregnated with resin and pre-compacted one with the other at a specified pressure and temperature,

the strip is laid up on a template having a flat or substantially flat application surface with a generally elongated shape, with a specified configuration corresponding to that of the desired profile and extending around a reference line, by gradually applying the strip and simultaneously deforming it along the said reference line, such that a gradual fanning of the fibers in the application plane is realized on the part or parts having a non-zero curvature radius.

This gradual fanning corresponds to an increasing widening of the space separating two fibers in the same tape, in the transverse direction of the strip, the gradual deformation of the angular opening existing between two fibers occurring in a uniform and regular fashion on the part of the strip having a non-zero curvature radius.

By “reference line” is meant the general line followed by the longitudinal axis around which the template, and therefore the corresponding profile in the plan, extends.

Thanks to the combination of the stacking of tapes with pre-impregnated crossed fibers on the one hand, and of this gradual application following the reference line on the other hand, this exceptional fanning, which turns out to be beneficial to the resilience of the member once this latter has solidified, is obtained in reproducible, reliable manner that can be realized in automatic or semi-automatic mode.

In advantageous embodiments one and/or the other of the following provisions are further used either singly or in combination:

the profile comprises at least a second part comprising a non-zero curvature radius;

the first and second parts have different curvature radii;

the strip being wound around a winding cylinder, the strip is laid up by unwinding the said cylinder onto the template while guiding it along its longitudinal movement by means of guiding of the same reference line as the template;

a strip is laid up in which the unidirectional fibers of at least two of the tapes are symmetrical in relation to the axis of the strip;

the composite strip is formed from three tapes superimposed and bonded to one another by compaction;

the parallel fibers of each of the tapes form an angle with the axis of the strip with a value of, respectively: 90°−a°, 90°, 90°+a°;

the respective angles are 90°−a and/or 90°−b and/or 90°+a and/or 90°+b;

a and/or b is such that: 10°<a<80°;

the fibers are made of carbon and the resin is epoxy resin;

the template has a cavity, for subsequently forming a profile of complementary shape, after stamping the strip in the cavity, and before hardening;

The template is in the shape of a beam having a rectangular or trapezoidal cross-profile, to form a profile in the shape of a U-beam after folding over the edges of the strip on the lateral surfaces of the template, and before hardening;

at least three successive layers of said composite strips are realized;

at least one complementary reinforcing tape made of unidirectional composite material whose reinforcing fibers run parallel to the axis is superimposed and/or inset between two layers in the longitudinal direction.

The invention also proposes a device implementing the method such as described above.

It also proposes a device for producing a profile made of a composite material with a configuration having at least a first part having a non-zero curvature radius, from at least one composite strip extending along a longitudinal axis, characterized in that the strip being formed of at least two tapes of unidirectional reinforcing fibers arranged in orientations different from that of the longitudinal axis of the stripstrip and each other, the tapes being pre-impregnated with resin and pre-compacted one with the other at a specified pressure and temperature,

the device comprises

at least one composite strip support base,

a template having a flat or substantially flat application surface with a generally elongated shape, with a specified configuration corresponding to the desired profile and extending around a reference line,

means for a gradual layup of the strip on the template comprising
means for gripping the base and for moving said base along said template,
means for pressing the tape by the base on the template's application surface,
means for guiding said base to cause a laying up of the strip on the application surface along the said reference line, such that a gradual fanning of the fibers in the application plane is realized on the part or parts having a non-zero curvature radius.

In advantageous embodiments the profile has at least a second part comprising a non-zero curvature radius.

Advantageously, the first and second parts have different curvature radii.

Also advantageously the base comprises at least one winding cylinder and the guiding means comprise two rails, ledges or guides ridges arranged on either side of the template, with the same reference line as the template.

In an advantageous embodiment the device further comprises means for forming the composite stripstrip comprising means for gradually applying the said tapes one upon the other by giving the parallel fibers of each of the said tapes a different orientation relative to the curvature radius or radii of the profile to be obtained and means for compacting one with the other to ensure their cohesion at a specified pressure and temperature.

Advantageously the pressure is between 0.5 and 5 absolute bars and the temperature is between 15° C. and 80° C., for example 0.9 bars and 40° C.

Also advantageously the means for forming the composite strip further comprise means for superimposing a third tape and of gradually applying said third tape to bond with the others by compaction, the parallel fibers of each of the said tapes forming, for example, an angle with the axis of the strip with a value of, respectively, 90°−a°, 90°, 90°+a°.

In another advantageous embodiment the template is in the shape of a cavity, and the device has means of stamping the strip in the cavity to then form a profile with a complementary shape before hardening.

Also advantageously the template is in the shape of a beam having a rectangular or trapezoidal cross-profile, and the device comprises means for folding over the edges of the strip on the lateral surfaces of the template to form a profile shaped as a U-beam before hardening.

The invention also proposes a profile realized according to the method described above.

It also proposes a profile made of composite material having a configuration with a first part having a non-zero curvature radius, comprising at least one composite strip extending along a longitudinal axis,

characterized in that the strip is formed by stacking at least two tapes of unidirectional reinforcing fibers arranged in orientations different to the longitudinal axis of the strip and each other, the tapes being pre-impregnated with resin and pre-compacted one with the other at a specified pressure and temperature, the strip being deformed according to said configuration and having a gradual fanning of fibers in the plane of application by regular angular opening deformation obtained over the width of the strip.

Advantageously, the profile has at least a second part having a non-zero curvature radius.

Also advantageously the unidirectional fibers of two of the tapes are symmetrical in relation to the axis of the strip, for example with angles relative to the axis of the strip of 90°−a and 90°+a, with a between 0° and 80°, advantageously 45° or 60°.

The invention also relates to an airplane fuselage member obtained from a profile made according to the method described above.

The invention will be better understood by reading the following embodiments described below as non-limiting examples.

The description refers to the accompanying drawings in which:

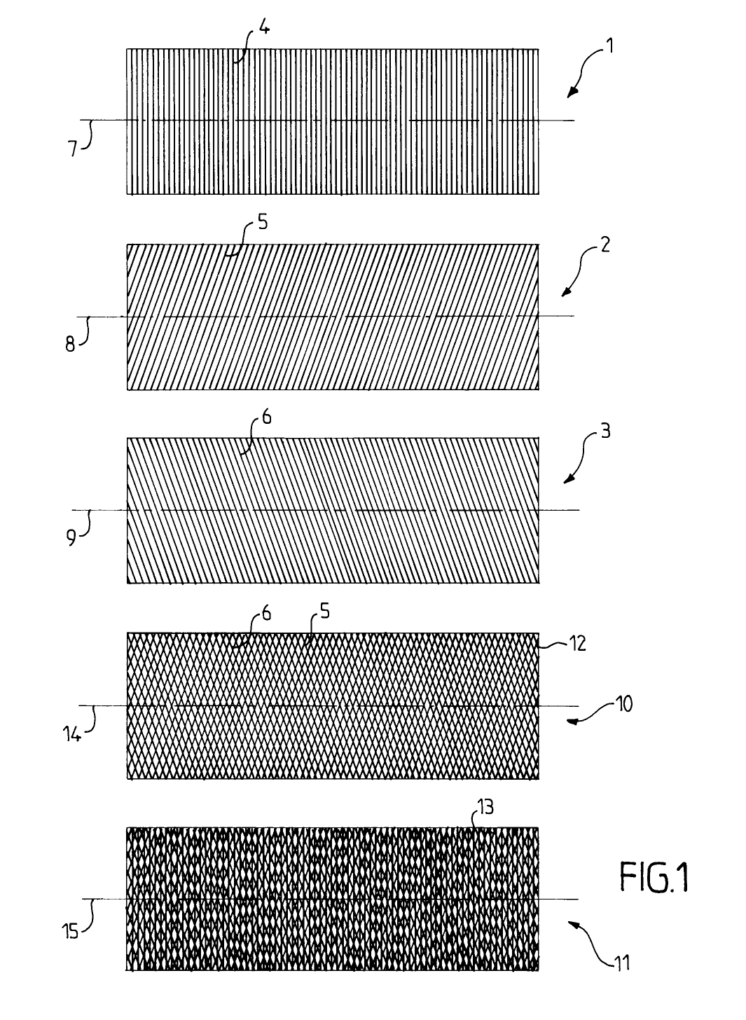

FIG. 1 shows composite strips formed of one, two or three tapes of parallel reinforcing fibers pre-impregnated with resin along an orientation d and usable according to the invention.

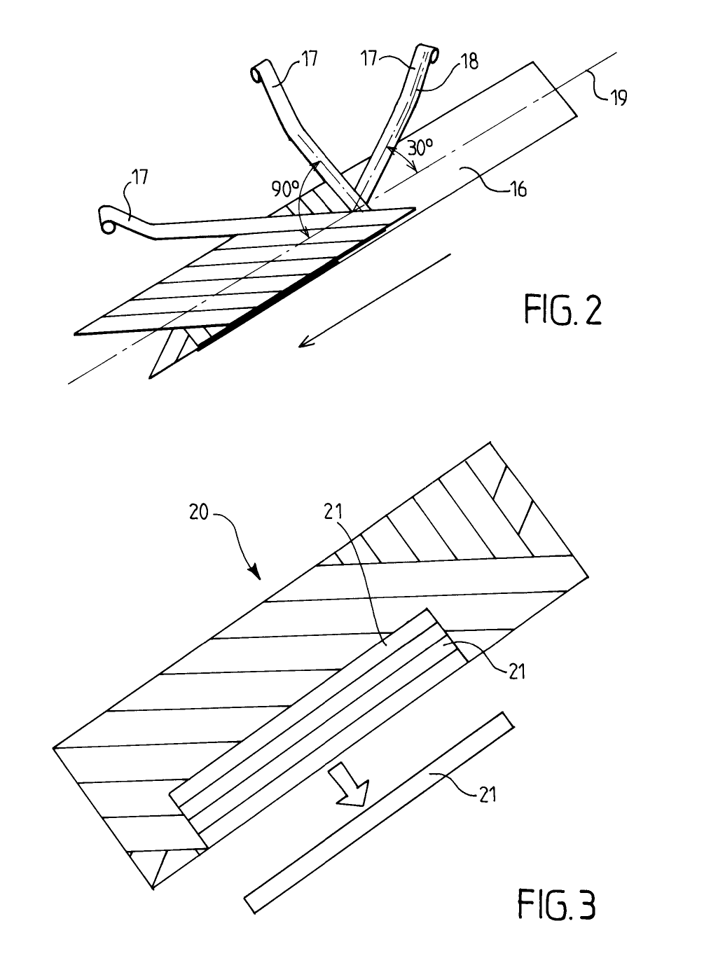

FIG. 2 is a top view in perspective showing the placement of tapes as described with reference to FIG. 1, superimposed before compaction to ensure cohesion.

FIG. 3 shows the cutting of strips obtained from the windings in FIG. 2, usable according to the invention.

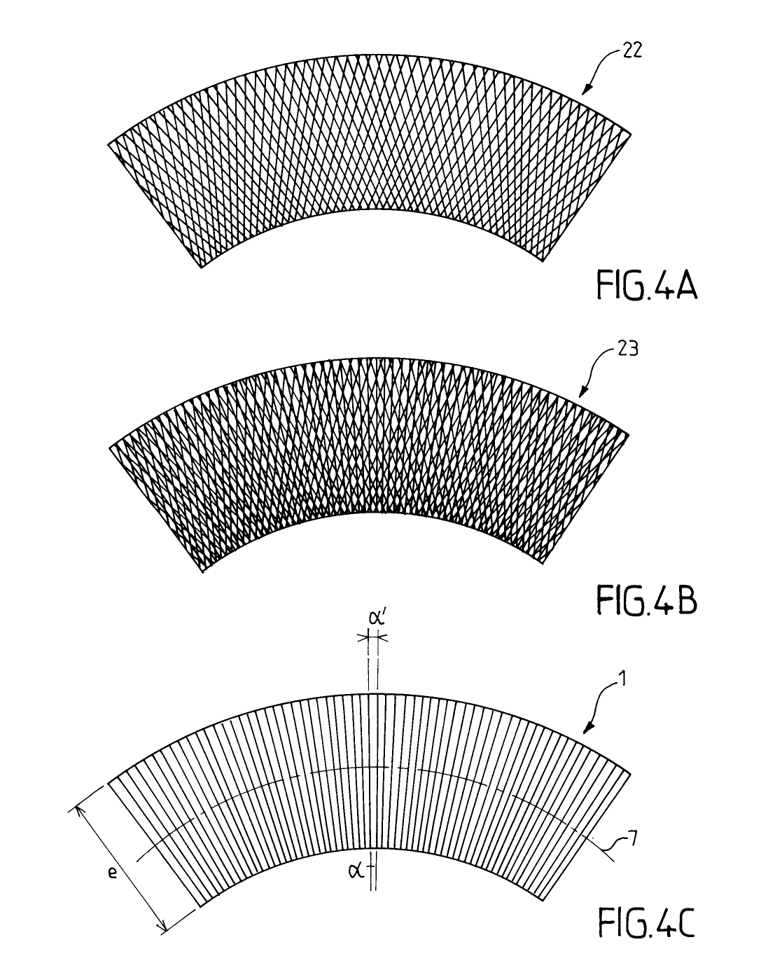

FIGS. 4A and 4B show a top view of curved strips obtained with two or three superimposed tapes corresponding to the tapes shown in FIG. 1.

FIG. 4C illustrates in a top view the gradual fanning of fibers (here perpendicular to the longitudinal axis) by regular and increasing deformation the angular opening obtained over the length of the strip, as obtained with the invention.

FIG. 5 is a partial perspective view of an embodiment of a device implementing the method according to the invention.

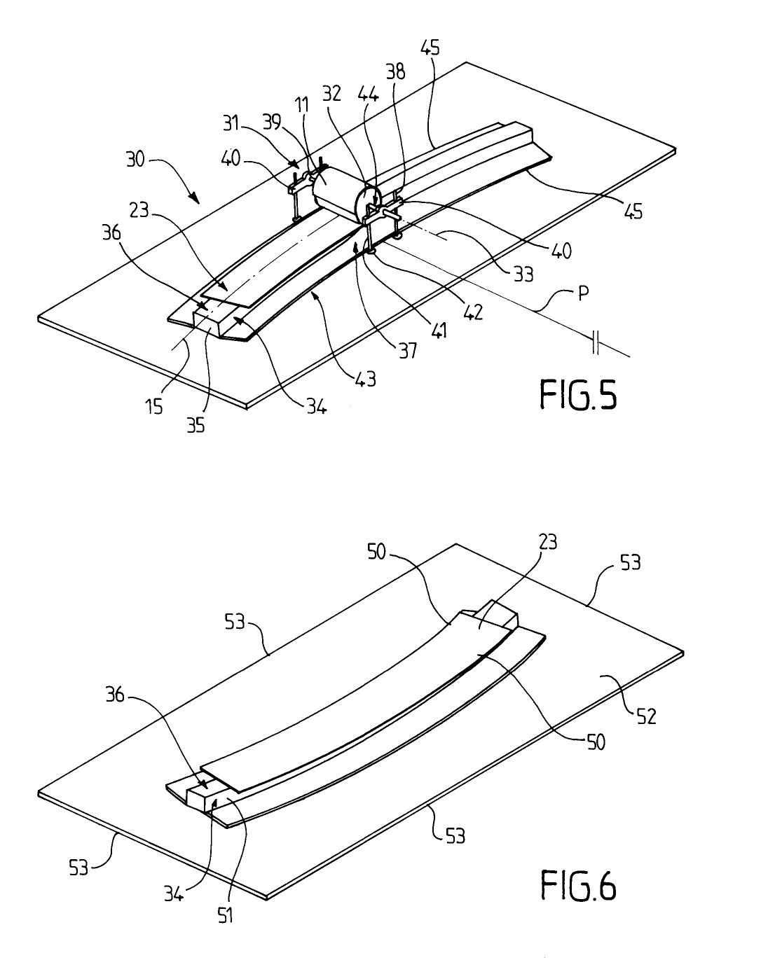

FIG. 6 shows the result before coating of a strip obtained with the device of FIG. 5.

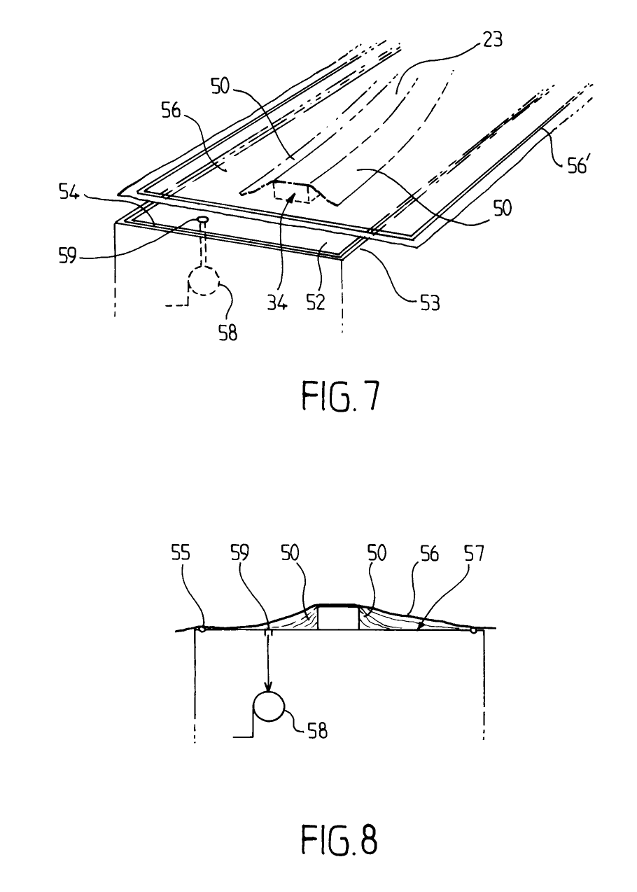

FIGS. 7 and 8 show the subsequent steps for obtaining a profile according to an embodiment of the invention, by vacuum-filling a space located between a layup sheet or cover and the curved strip obtained with the invention.

FIG. 9 is a partial perspective and cross-profile view, after turning over and inserting the profile in a mold for the hardening of the profile in a manner known in itself by pressurization and vacuum curing.

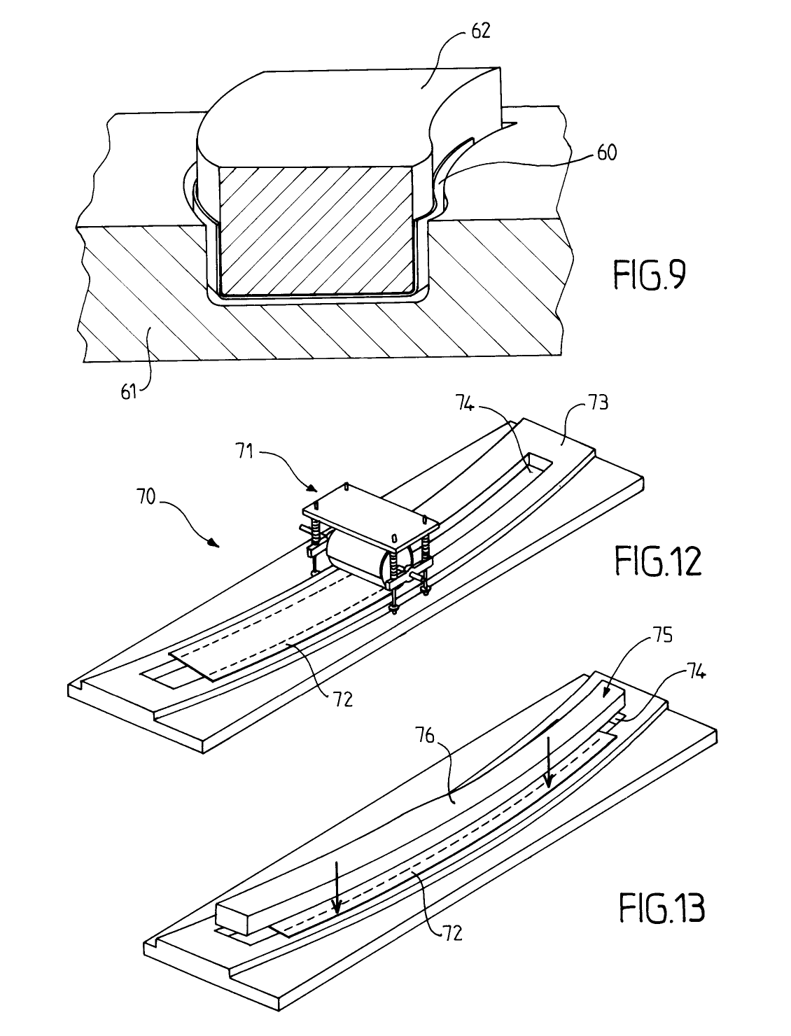

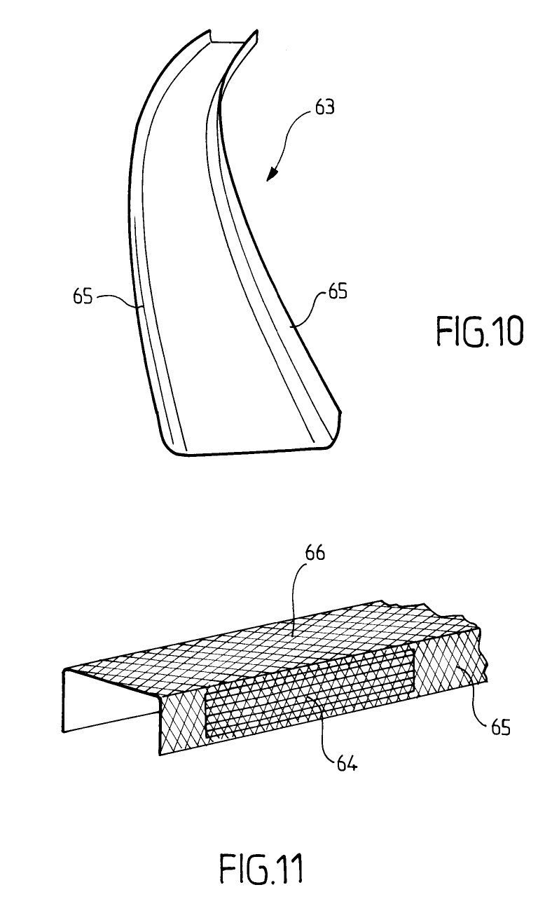

FIGS. 10 and 11 show in perspective embodiments of curved sections or parts of sections obtained with the invention.

FIGS. 12 and 13 shows in perspective another embodiment of a device for sections according to the invention, for which the profile in U or C is obtained by stamping the pre-stretched strip in a curved manner.

FIG. 1 shows, schematically, three rectangular tapes 1, 2, 3 consisting of reinforcing fibers 4, 5, 6 arranged in orientations different from those of the longitudinal axis 7, 8, 9 of the tape in question.

Each of these tapes is pre-impregnated with resin for example of epoxy type and will allow construction of a strip usable according to the invention.

But any type of thermoset or thermoplastic resin is of course usable.

Examples of such strips were represented in 10 and 11 in FIG. 1.

They are formed by stacking two tapes (strip 10) or three tapes (strip 11).

More specifically, strip 10 is formed by the stacking of tapes 2 and 3 whose unidirectional fibers form with their respective axes, as shown in the figure, an angle of 15°, which gives a lattice structure 12 (or beehive).

The strip 11 is obtained by the superposition of three tapes, namely a superposition of tapes 1, 2 and 3 giving a denser structure 13.

More specifically, each of strips 10 and 11 is therefore formed by the stacking of corresponding tapes made of unidirectional reinforcement wire, which are therefore arranged in orientations different to that of the longitudinal axis of the strip in question, said tapes being pre-impregnated with resin and pre-compacted one with the other at a specified pressure and temperature.

These will depend at the same time on the resin used, the fibers used and the strength and resilience of the profile required after hardening.

Advantageously the pressure of compaction may for example be around 0.8 bars absolute, for example obtained by placing the tapes in a vacuum and plating them to one another in a corresponding enclosure, but can also be obtained by external pressure in a press, or using a press roller at pressures up to 3, 4 or even 5 bars.

The specified temperature used for this preparation of the multi-tape strips is advantageously the ambient temperature, giving good flexibility to the materials without fast hardening of the resins. But a cooler and/or higher temperature is also possible, for practical reasons at the discretion of people in the field.

FIG. 2 represents a means of realizing a strip used with the method according to the invention.

To achieve this, around a rectangular base 16 are wound, successively, three identical unidirectional pre-impregnated strips 17 whose fibers 18 are located in the longitudinal direction by giving them different coating angles around the rectangular base 16, for example and as shown in the figure, angles of 30°, 90° and 120°, respectively.

Thus a ribbon of three superimposed tapes is formed, the angles of whose fibers are therefore arranged in orientations different to those of the axis of the base, and which will be compacted with one another so as to obtain the tape 20 as shown in FIG. 3 and which corresponds to one of the surfaces of the base 16.

From this ribbon it is possible to cut the strips 21 of multidirectional tapes of the type of strip 11 represented on FIG. 1.

From strips 10, 11, 21, thus comprising unidirectional reinforcing fibers arranged in orientations different from those of the longitudinal axis of the strip and each other, the strip is laid up on a template as will be described below with reference to FIG. 5 or FIG. 12.

FIGS. 4A and 4B show the deformed strips 22 and 23 obtained according to the invention, the curved parts of the profile having a gradual fanning of the fibers, as shown by way of illustration in FIG. 4C applied to a single tape 1 whose fibers are perpendicular to the axis 7 of the tape in the application plane.

Thus can be observed, according to the invention, a regular or substantially regular deformation of the spacing between two adjacent fibers which gradually goes from a small value d, to a larger value d′ on a flat surface.

The angle between two notably adjacent fibers is maintained or substantially maintained over the width of the strip, given the regular fanning carried out as described above.

If the curved portion of the strip always has an identical curvature radius (case of a circle), the deformation of the distances along a same line parallel to the reference line will be identical between two fibers initially separated, before bending, by a same width.

If on the contrary the curvature radius is variable, the deformation will be therefore be variable in a mathematically consistent manner according to the variations of said curvature radius on the corresponding parts.

Hereinafter, the same reference numbers will be used to designate identical or similar elements.

FIG. 5 shows a device 30 according to a first embodiment of the invention, arranged to realize a U-shaped profile made of composite material with a curved shape along a non-zero curvature radius, from a composite strip, for example strip 11 formed of three pre-impregnated superimposed tapes 1,2,3 which extend along its longitudinal axis 15 to obtain the curved strip 23.

The device 30 comprises composite strip support 31 with a winding cylinder 32, on which strip 11 was wound and with an axis 33 perpendicular to the longitudinal axis 15 of said strip. Means of locomotion (not shown) allow the regular unwinding of this cylinder.

In addition, the device 30 comprises a template 34 formed of a curved parallelepiped block 35 with a shape that complements the inner part of the U-shaped profile to be realized, said template having a flat or substantially flat application surface 36 with a generally elongated shape having a specified configuration corresponding to that of the profile to be obtained.

The device 30 further comprises means 37 for gradually laying up the strip on the template. These means comprise means 38 of gripping the base for example made of a shaft 39 supported on both sides of the cylinder by two symmetrical mobile gantries 40, whose posts 41 comprise feet mounted on wheels 42 arranged to follow the curvature of the means 43 of guiding the base, which will be described below.

The means of laying up 37 also comprise means of locomotion, which may be identical to those mentioned above, for moving the roller along the template, and means 44 for pressing the tape by the base on the application surface 36, formed for example of a system of vertical springs allowing to compensate for the gradual loss of thickness of the roll after depositing the strip on said base surface.

The means of pressurization may also be a device allowing the horizontal part of the gantries 40 to slide easily, for example consisting of low friction rings on secured parallel shafts located along the support posts 41, because of the weight of the roll itself.

A pressure of, for example, between 200 g and 3 kg and advantageously 1 kg is thus applied when applying the strip to the template, which will allow a good gradual fanning of the fibers in the application plane.

The means 43 for guiding the base to generate the laying up of the strip comprise two tracks and/or guide rims 45 able to operate in conjunction with the wheels 42 of the roll support gantry's feet, and having the same reference line as the template and/or profile.

In FIG. 5, as shown, the rails therefore have the same curvature radii (fixed or variable) as the curvature radius of the profile to be realized.

Other means for guiding may of course be used.

FIG. 6 shows the first phase of realization of the embodiment of the profile more particularly described here, the means of laying up having been removed after completion thereof.

The strip 23 thus realized rests on the upper surface 36 of template 34, the edges 50 of the strip extending laterally beyond this surface and will require to be folded over onto the lateral surfaces 51 of the template.

To achieve this, the device more particularly described here provides that the template and guiding means rest on a table 52 fitted on its periphery 53 with tightness means.

The device to configure the desired final U-shaped profile from the intermediate profile 23 above is more specifically described with reference to FIGS. 7 and 8.

FIG. 7 shows the strip 23 in perspective that rests on the template 34, itself secured to the table 52 whose edges 53 comprise grooves 54 fitted with seals 55, which will ensure good tightness of the leak-proof cloth or cover 56 (secured to a support frame 56), arranged to cover the table and the whole of the profile.

FIG. 8 represents more particularly the plating of the lateral edges 50 of the profile by vacuum-draught the volume between the surface of the table 57 and the cloth 56.

Using a vacuum pump 58 connected to the surface of the table at 59, air is exhausted so that the cloth 56 is gradually plated to the edges 50 of the profile on the template.

Once the profile is in its final formal configuration, it is then polymerized under pressure at high temperature in a manner known in itself.

To achieve this and for example, the profile is placed on a hollow template in a metal counter-mold comprising a silicone cover, which is pressed.

Inside the hollow template, a high temperature water flow is realized that, together with the pressure applied, allows the curing cycles previously defined to be met.

Then at the end of the molding and curing stages, the member is passed on to routing and ultrasonic inspection,

to obtain the final profile 63 (see FIG. 10) which will, for example, be used for an aircraft fuselage frame.

FIG. 9 represents another embodiment envisaged to complete the manufacturing of the final profile.

To do this, the not yet hardened profile 60, is introduced into the counter-mold 61 having a complementary shape. A silicon core 62 is then placed in the profile, also having a shape complementary to that of the desired profile, for instance made of wood, then put under pressure, for example by placing in vacuum or by inflating the core.

Then block 62 is removed (or not) before curing in a vacuum and under pressure as described before.

Here also a system built into the mold to produce heating, vacuum and pressure (not shown) is provided and known in itself.

According to an embodiment of the invention, it is possible to realize a second strip, a third strip, etc., which are superimposed onto the first strip before curing, possibly with slightly different settings on the device for depositing the first strip described.

It is also possible, as shown in FIG. 11, to add unidirectional reinforcing ribbons 64 positioned on the lateral surfaces 65 or on the main surface 66 of the U-shaped or parallelepipedal profile, again with possible pre-compaction followed by molding and curing.

Such reinforcing means are specified according to the stresses and strength required in the context of the use of the profile in question and are deposited in a manner known ny the person skilled in the art, by the lateral unwinding of ribbons, for example from a reel of unidirectional tape of fibers with directions parallel or not at the reference line, of adequate width, automatically or semi-automatically, the ribbons being, for example, compressed by roller with a vertical axis in the case of depositing on the lateral edges of the U.

Another embodiment of a device 70 according to the invention is shown (partially) with reference to FIGS. 12 and 13. It comprises means 71 to layup the strip 72 of the type described with reference to FIG. 5, but this time on a female mold 73 provided with a recess 74 corresponding to the configuration of the desired profile, the template having in fact the shape of a cavity.

The device also comprises (see FIG. 13) stamping means 75 comprising a core 76, for example made of semi-rigid material, with a non-deformable or other cross-profile, with a shape that complements that of the recess 74, which, when it will be applied onto the strip 72 will allow the configuration of the U-shaped template to be obtained by stamping before hardening.

The realization of a U-shaped profile according to the embodiment of the invention more particularly described in FIGS. 1 to 11 will now be described.

From three unidirectional tapes made of carbon epoxy whose fibers are oriented in the direction of the longitudinal axis of the strip, a semi-product is realized that will allow the strips 21 to be obtained by cutting, as shown with reference to FIG. 2.

The fiber orientations are, for example minus 45°, (or minus 30°), 90° (plus 30° or) plus 45°.

The operation can be performed from rolls comprising the unidirectional pre-impregnated tapes in a semi-automated or automated manner.

A pre-compaction before cutting of the strips to ensure cohesion and cutting to the desired widths, for example 150 mm, is then performed (see FIG. 3).

The resulting strip 21 is, for example wound on the roller 32.

As stated above the principle is to achieve a gradual balanced fanning without dissociation of fibers one from another, thereby obtaining particularly high performance, in resilience in particular, on templates that, being curved, have traditionally required complex assemblies.

With reference to FIGS. 5, 6 and following, the roller 11 is then positioned on the unwinding device (support and locomotion means) of the strip 21.

The unwinding system is guided by the inner and outer guide rails 45, for example circular if the profile is an arc of a circle.

The layup is then performed gradually on the template for example made of wood or of silicone with higher or lower hardness.

The deformation of the opening angle of the multi-axial strip then occurs in uniform manner, the unwinding occurring automatically or semi-automatically at low speed, for example 1 m per minute.

This gives a strip of the type shown in FIG. 4B with excellent fanning, resting on the template 34 (see FIG. 7).

Then the frame 56′ fitted with its expandable silicone cover 56 is positioned, to plate the returns, i.e. the flanks 50 of the C- or U-shaped profile on the template 34.

Referring to FIG. 8, a vacuum is realized between the silicone cover 56 and the surface 57 of the table, which effectively plates the edges 50 along the template 34.

Then, the layup having been performed correctly, unidirectional reinforcements are possibly added on the edges and/or the top of the profile and possibly the operations are repeated to realize a second strip or a third strip on the first profile obtained so as to obtain a multi-strip multi-axial composite profile with or without reinforcement.

The profile thus obtained, which is a semi-product, is then hardened. To do this, it is placed in a mold furnished with a cavity of complementary shape (see FIG. 9), then a silicone core 62 is inserted into the product before pressing the assembly to plate the profile against the walls of said mold pressing it, then curing under pressure or vacuum is performed in a manner known in itself.

It goes without saying and it also follows from the foregoing that the present invention is not limited to the embodiments described more specifically. On the contrary, it encompasses all variants and in particular those in which the shape of the template, and therefore of the profile obtained, comprises several different curvature radii including those of opposite directions.

1. A method for realizing a profile (63) made of composite material having a configuration with at least a first part having a non-zero curvature radius, from at least one composite strip (11) extending along a longitudinal axis,
characterized in that the strip being formed by stacking at least two tapes of unidirectional reinforcing fibers (4, 5, 6) arranged in orientations different to the longitudinal axis of the strip and each other, the tapes being pre-impregnated with resin and pre-compacted one with the other at a specified pressure and temperature,
the strip is laid up on a template (34, 73) having a flat or substantially flat application surface (36) with a generally elongated shape, with a specified configuration corresponding to the desired profile and extending around a reference line, by gradually applying the strip and simultaneously deforming it along the said reference line, such that a gradual fanning of the fibers in the application plane is realized on the part or parts having a non-zero curvature radius.

2. A method according to claim 1, characterized in that the profile comprises at least a second part comprising a non-zero curvature radius.

3. A method according to claim 2, characterized in that the first and second parts have different curvature radii.

4. A method according to claim 1, characterized in that the strip (11) being wound around a winding cylinder (32), the strip is laid up by unwinding the said cylinder onto the template (34) while guiding it along its longitudinal movement by means (43) of guiding of the same reference line as the template.

5. A method according to claim 1, characterized in that a strip is laid up in which the unidirectional fibers of at least two of the tapes are symmetrical in relation to the axis of the strip.

6. A method according to claim 5, characterized in that the composite strip is formed from three superimposed tapes bonded to each other by compaction, the parallel fibers of each of the tapes forming an angle to the axis of the strip with a value of 90°−a°, 90°, 90°+a° respectively.

7. A method according to claim 6, characterized in that a is such that: 10°<a<80°.

8. A method according to claim 1, characterized in that the fibers are made of carbon and the resin is an epoxy resin.

9. A method according to claim 1, characterized in that the template (73, 74) has a cavity (74), for subsequently forming a profile of complementary shape, after stamping the strip in the cavity, and before hardening.

10. A method according to claim 1, characterized in that the template (34) is in the shape of a beam having a rectangular or trapezoidal cross-profile, for forming a profile in the shape of a U-beam after folding over the edges of the strip on the lateral surfaces of the template, and before hardening.

11. A method according to claim 9, characterized in that at least two successive layers of said composite strips are realized.

12. A method according to claim 1, characterized in that at least one complementary reinforcing tape (64) made of unidirectional composite material whose reinforcing fibers run parallel to the axis is superimposed and/or inset between two layers in the longitudinal direction.

13. A device (30, 70) for realizing a composite material profile having a configuration with at least a first part having a non-zero curvature radius, from at least one composite strip (11) extending along a longitudinal axis (15), characterized in that the strip being formed of at least two tapes (1, 2, 3) of unidirectional reinforcing fibers arranged according to orientations different to that of the longitudinal axis of the strip and each other, the tapes being pre-impregnated with resin and pre-compacted with one another at a specified pressure and temperature,
the device comprises
at least one composite strip (11) support base (31),
a template (34) having a flat or substantially flat application surface (36) with a generally elongated shape, with a specified configuration corresponding to the desired profile and extending around a reference line,
means (37) for gradually laying up the strip on the template comprising
means (38) for gripping the base and of moving said base along said template,
means (44) for pressing the tape by the base on the template's application surface,
means (43) for guiding said base to cause a laying up of the strip on the application surface along the said reference line, such that a gradual fanning of the fibers in the application plane is realized on the part or parts having a non-zero curvature radius.

14. A device according to claim 13, characterized in that the template has at least one second part comprising a non-zero curvature radius.

15. A device according to claim 14, characterized in that the first and second parts have different curvature radii.

16. A device according to claim 13, characterized in that the base comprises at least one winding cylinder (32) and in that the guiding means comprise two rails, ledges or guides ridges (45) arranged on either side of the template, with the same reference line as the template.

17. A device according to claim 13, characterized in that it further comprises means for forming the composite strip comprising means for gradually applying the said tapes one upon the other by giving the parallel fibers of each of the said tapes a different orientation relative to the curvature radius or radii of the profile to be obtained and means of compaction of one with the other to ensure their cohesion at a specified pressure and temperature.

18. A device according to claim 17, characterized in that the pressure is between 0.5 and 5 bars and the temperature is between 15° C. and 80° C.

19. A device according to claim 13, characterized in that the means for forming the composite strip further comprise means for superimposing a third tape and of gradually applying said third tape to bond it to the others by compaction, the parallel fibers of each of the said tapes forming an angle with the axis of the strip with the value of, respectively, 90°−a°, 90°, 90°+a°.

20. A device according to claim 13, characterized in that the template (73) is in the shape of a cavity (74) and in that it includes means of stamping the strip in the cavity for subsequently forming a template with a complementary shape, before hardening.

21. A device according to claim 13, characterized in that the template (35) is in the shape of a beam having a rectangular or trapezoidal cross-section, and in that it comprises means (56, 58, 59) for folding over the edges of the strip on the lateral surfaces of the template to form a profile shaped as a U-beam before hardening.

22. A device according to claim 13, characterized in that it comprises means of applying at least three successive layers of said composite strips onto the template.

23. A device according to claim 22, characterized in that it comprises means for superimposing on or between two layers at least one additional reinforcing unidirectional strip made of composite material.

24. A profile made of composite material having a configuration with a first part having a non-zero curvature radius, comprising at least one composite strip (11) extending along a longitudinal axis,
characterized in that the strip is formed by stacking at least two tapes (1, 2, 3) of unidirectional reinforcing fibers (4, 5, 6) arranged in orientations different to the longitudinal axis of the strip and each others, the tapes being pre-impregnated with resin and pre-compacted one with the other at a specified pressure and temperature, the strip being deformed according to said configuration and having a gradual fanning of fibers in the plane of application by regular angular opening deformation obtained over the width of the strip.

25. A profile made of composite material according to claim 24, characterized in that the template has at least one second part having a non-zero curvature radius.

26. A profile according to claim 24, characterized in that the unidirectional fibers of two of the tapes are symmetrical in relation to the axis of the strip.

27. A profile according to claim 24, characterized in that the composite strip comprises three superimposed tapes bonded to each other by compaction, the parallel fibers of each of the tapes forming an angle to the axis of the strip with a value of 90°−a°, 90°, 90°+a° respectively.

28. A profile according to claim 27, characterized in that a is such that: 10°<a<80°.

29. A profile according to claim 24, characterized in that the fibers are made of carbon and the resin is epoxy resin.

30. A member for an airplane fuselage, characterized in that it is obtained from at least one profile realized from the method according to claim 1.
